(19) United States
(12) Patent Application Publication
(10) Pub. No.: US 2026/0321111 A1
(43) Pub. Date: Oct. 15, 2026

(54) WINDOW BLIND SYSTEMS AND METHODS FOR OPERATING SAME

(71) Applicant: MORGAN SOLAR INC., Toronto (CA)

(72) Inventors: Allan TAMESHTIT, Toronto (CA); John Paul MORGAN, Toronto (CA)

(21) Appl. No.: 19/108,493

(22) PCT Filed: Sep. 6, 2023
(86) PCT No.: PCT/IB2023/058822

§ 371 Date: Mar. 4, 2025

Related U.S. Application Data
(60) Provisional application No. 63/403,955, filed on Sep. 6, 2022.

(51) Int. Cl. G08B 13/08; E06B 9/325; E06B 9/68; E06B 9/72; G08B 13/16; G08B 13/196; G08B 15/00

(52) U.S. Cl. CPC G08B 13/08; E06B 9/325; E06B 9/72; G08B 13/1672; G08B 13/19602; G08B 15/00; E06B 2009/6818

(57) ABSTRACT

A method for deterring theft from a home or business equipped with an alarm system and a window blind, the method including activating a motor with a controller to effect movement of the window blind, said controller being connected to a processor operatively connected to the alarm system; obtaining, by the processor, at least one of information relating to environmental or use conditions of the home or business; and controlling the motor to open, close, or move the blinds.

### CROSS-REFERENCE

The present application claims priority to U.S. Provisional Patent Application No. 63/403,955, entitled “Window Blind Systems and Methods for Operating Same,” filed 6 Sep. 2022, the entirety of which is incorporated by reference herein.

### TECHNICAL FIELD

The present technology relates generally to window blind systems, particularly to window blind systems for security and/or convenience.

### BACKGROUND

Window blind systems are commonly installed to manage sunlight entering a home or business through windows, as well as to limit the ability to see inside the home or business from an exterior thereof.

There are various situations that dictate whether it would be preferable to have window blinds open or closed, such as the activities of people within the home or business, time of day, etc. In some cases, it could be difficult, time consuming, and/or inconvenient to open or close window blind systems at the particular moment it would be most preferable to do so.

Therefore, there remains a desire to develop a window blind system for managing light transmitted through a window.

### SUMMARY

It is an object of the present technology to ameliorate at least some of the inconveniences present in the prior art.

According to one aspect of the present technology, there is provided a method for deterring theft from a home or business equipped with an alarm system and a window blind, the method including activating a motor with a controller to effect movement of the window blind, said controller being connected to a processor operatively connected to the alarm system; obtaining, by the processor, at least one of a time information and a date information; in response to determining, by the processor, that it is night based on the at least one of the time information and the date information and in response to the alarm system being armed with an away status, sending, by the processor, a close signal to the controller; and in response to receiving the close signal, sending, by the controller, a signal to the motor to close the blinds.

In some embodiments, the method further includes determining, by the processor, that it is not night; and in response to the alarm system being armed with the away status and determining that it is not night, sending, by the controller, a signal to the motor to open the window blind.

In some embodiments, the method further includes in response to receiving the close signal, causing a light operatively connected to the window blind assembly to turn on.

In some embodiments, the method further includes in response to receiving the close signal, causing a light operatively connected to the window blind assembly to turn on and flicker to simulate a television display.

According to another aspect of the present technology, there is provided a method for deterring theft from a house equipped with an alarm system and a window blind assembly for a window, the window blind having a movement sensor capable of detecting movement of a window blind of the window blind assembly, the method including detecting, by the movement sensor, the window blind being moved from a standby position; in response to the alarm system being armed with an away status and in response to the movement sensor detecting movement of the window blind from the standby position: activating, by a controller of the window blind assembly, an intruder signal.

In some embodiments, the intruder signal includes at least one of an alarm, an alert to a smart phone, an alert to police, an alert to a security firm, a voice warning, and a light signal.

According to yet another aspect of the present technology, there is provided a method for deterring theft from a house, the house having at least one window equipped with a window blind assembly, the window blind assembly having a window blind and a motor for selectively moving the window blind, the method including detecting, by a motion sensor in communication with a controller of the window blind assembly, motion of an interloper exterior and proximal to the at least one window; and in response to detecting motion of the interloper, sending a signal to the controller to actuate the motor to thereby close the window blind.

According to yet another aspect of the present technology, there is provided a method for operating a wake-up alarm in concert with opening of a window blind of a window blind assembly, the method including receiving, by a controller of the window blind assembly, a selection of an automatic blind opening mode via a device in communication with the controller; receiving, by the controller, a selection of the wake-up alarm; and in response to the selection of the automatic blind opening mode and in response to a selection of the wake-up alarm including a selection of the automatic blind opening mode at a given time: causing, by the controller, a motor of the window blind assembly to open the window blind at the given time.

In some embodiments, the wake-up alarm is a crescendo alarm which when activated increases in volume over a crescendo period T>0.

In some embodiments, causing the motor to open the window blind at the given time includes causing the window blind to gradually open over an opening period S>0 that at least partially overlaps with the crescendo period T.

In some embodiments, the device is a smart phone. In some embodiments, the device is a remote control.

According to yet another aspect of the present technology, there is provided a window blind including a first panel of spaced apart slats, the distance between adjacent slats being h1 and the width of each slat being w1; a second panel parallel to the first panel, said second panel having slats capable of being spaced apart such that the distance between adjacent slats is h2 and the width of each slat is w2, the slats of the second panel capable of translating, wherein: to open the window blind, the slats of the second panel are translated to align with the slats of the first panel to thereby allow light to enter between the slats, and to close the window blind, the slats of the second panel are translated so as to be staggered with respect to the slats of the first panel to thereby block the light.

In some embodiments, h2=w1=h1=w2.

In some embodiments, the slats of the second panel can translate with the assistance of a motor.

In some embodiments, the slats of the first panel contain electrochromic material.

In some embodiments, the window blind further includes a light sensor that can influence the degree of dimming of the electrochromic material.

In some embodiments, the slats of the second panel can assume a retracted configuration in which the slats are stacked adjacent to each other.

In some embodiments, the slats of the second panel contain photovoltaic cells which power the electrochromic material of the first panel.

In some embodiments, at least one of the slats of the first panel and the slats of the second panel contain photovoltaic cells.

In some embodiments, the slats of the first panel are disposed between two panes of a window. In some embodiments, the slats of the second panel are disposed between the two panes of the window.

In some embodiments, the slats of the first panel contain electrochromic material.

According to yet another aspect of the present technology, there is provided a window blind system for installing in a room containing a bed, the window blind system including a window blind arranged to selectively cover a window of the room; a motor to open and close the window blind; a controller for controlling the motor; and a bed occupant sensor configured for sensing whether a person in the room is occupying the bed, the bed occupant sensor being in communication with the controller, wherein when the bed occupant sensor senses that the person has occupied the bed, the bed occupant sensor sends a signal that causes the controller to close the blind, and the person has gotten out of the bed, the bed occupant sensor sends a signal that causes the controller to open the blind.

In some embodiments, the bed occupant sensor is capable of determining whether more than one person is occupying the bed such that the signal that causes the controller to close the blind is sent only after two persons occupy the bed; and the signal that causes the controller to open the blind is sent only after no persons occupy the bed.

In some embodiments, the bed occupant sensor is triggered by the weight of the person.

According to yet another aspect of the present technology, there is provided a window blind system including a window blind; a motor for operating the window blind; a controller to control the motor; and a sound sensor in communication with the controller, said sound sensor capable of being trained to detect an alarm sound, wherein the sound sensor sends a signal to the controller to open the window blind in response to the sound sensor detecting the alarm sound.

According to yet another aspect of the present technology, there is provided a computer readable storage medium having computer program instructions stored therein for deterring theft from a home or business equipped with an alarm system and a window blind, which instructions when executed on a computer system cause the computer system to: activate a motor with a controller to effect movement of the window blind, said controller being connected to a processor operatively connected to the alarm system; obtain, by the processor, at least one of a time information and a date information; in response to determining, by the processor, that it is night based on the at least one of the time information and the date information and in response to the alarm system being armed with an away status, send, by the processor, a close signal to the controller; and in response to receiving the close signal, send, by the controller, a signal to the motor to close the window blind. In some embodiments, the computer readable storage medium is non-transitory.

According to yet another aspect of the present technology, there is provided a computer readable storage medium having computer program instructions stored therein for deterring theft from a home or business equipped with an alarm system and a window blind assembly having a movement sensor to detect the window blind being moved from a standby position, which instructions when executed on a computer system cause: in response to the alarm system being armed with an away status and in response to the movement sensor detecting movement of the window blind from the standby position, a controller of the window blind system to activate an intruder signal. In some embodiments, the computer readable storage medium is non-transitory.

According to yet another aspect of the present technology, there is provided a computer readable storage medium having computer program instructions stored therein for increasing privacy of a home or business equipped with a window blind assembly that includes a window blind and a motor controlled by a controller for selectively moving the window blind, which instructions when executed on a computer system cause: a detection signal to be processed, said detection signal sent by a motion sensor capable of detecting motion of an interloper exterior and proximal to the at least one window; and in response to processing the detection signal, an actuating signal to be sent to the controller to actuate the motor to thereby close the window blind. In some embodiments, the computer readable storage medium is non-transitory.

According to yet another aspect of the present technology, there is provided a computer readable storage medium having computer program instructions stored therein for operating a motorized window blind in concert with a wake-up alarm, which instructions when executed on a computer system cause the computer system to: in response to a) an automatic blind opening mode being selected with a device and b) the wake-up alarm being set for a given time, activate a motor to open the window blind. In some embodiments, the computer readable storage medium is non-transitory.

According to yet another aspect of the present technology, there is provided a window blind system including a plurality of rotatable slats; at least one probing slat including a light sensor; at least one motor for operating the plurality of rotatable slats and the at least one probing slat; and a controller for controlling the at least one motor, the controller being communicatively connected to the light sensor of the at least one probing slat wherein the at least one probing slat automatically rotates over a range of angles to enable the light sensor to determine an intensity profile used by the controller, the operation of the motor being based at least in part on the intensity profile.

In some embodiments, when the at least one probing slat rotates, the plurality of rotatable slats also rotate.

In some embodiments, the plurality of rotatable slats includes photovoltaic material. In some embodiments, the light sensor includes photovoltaic material.

In some embodiments, the controller is configured to, based on the intensity profile, identify an angle for the plurality of rotatable slats that maximizes energy generation from the photovoltaic material.

In some embodiments, when the window blind is installed in an interior of a building, the intensity profile is used for heat management in the building.

In some embodiments, the probing slat rotate over the range of angles during a period of time that is greater than twelve hours.

In some embodiments, the probing slat rotates over the range of angles during a period of time that is less than a minute.

In some embodiments, after the period of time, the probing slat does not rotate for at least ten minutes before a subsequent period of rotation over the range of angles.

In some embodiments, the probing slat rotates over the range of angles during a period of time that is greater than one hour.

In some embodiments, the time between the period of time and a subsequent period of time of rotation is less than one minute.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

Embodiments will now be described more fully with reference to the accompanying drawings in which:

FIG. 1 is a schematic illustration of a window blind system according to an embodiment of the present technology;

FIG. 2 is a flowchart illustrating a method of operating the window blind system of FIG. 1;

FIG. 3 is a schematic illustration of a window blind system according to another embodiment of the present technology;

FIG. 4 is a flowchart illustrating a method of operating the window blind system of FIG. 3;

FIG. 5 is a schematic illustration of a window blind system according to yet another embodiment of the present technology;

FIG. 6 is a flowchart illustrating a method of operating the window blind system of FIG. 5;

FIG. 7 is a schematic illustration of a window blind system according to yet another embodiment of the present technology;

FIG. 8 is a flowchart illustrating a method of operating the window blind system of FIG. 7;

FIG. 9 is a schematic illustration of a window blind system according to yet another embodiment of the present technology;

FIG. 10 is a schematic illustration of a window blind system according to yet another embodiment of the present technology;

FIG. 11 is a side elevation view of a window blind of the window blind system of FIG. 1, with the window blind being in a closed arrangement;

FIG. 12 is the side elevation view of the window blind of FIG. 11, with the window blind being in an opened arrangement;

FIG. 13 is a top, cross-sectional view of a window blind according to another embodiment of the present technology, with the window blind being in a closed arrangement;

FIG. 14 is the top, cross-sectional view of the window blind of FIG. 13, with the window blind being in an opened arrangement;

FIG. 15 is a schematic illustration of a window blind system according to yet another embodiment of the present technology;

FIG. 16 is a side elevation view of the window blind system of FIG. 15, with a probing slat of the window blind being in a vertical arrangement;

FIG. 17 is a side elevation view of the window blind of FIG. 15, with the probing slat of the window blind being arranged at a minimum range angle; and

FIG. 18 is the side elevation view of the window blind of FIG. 16, with the probing slat of the window blind being arranged at a maximum range angle.

Unless otherwise indicated, it should be noted that the Figures may not be drawn to scale.

### DETAILED DESCRIPTION

For a better understanding of various features of the present technology, reference is made to the following description and the accompanying Figures. A person skilled in the art would understand that modifications to the embodiments described below are possible and may be necessary for specific applications.

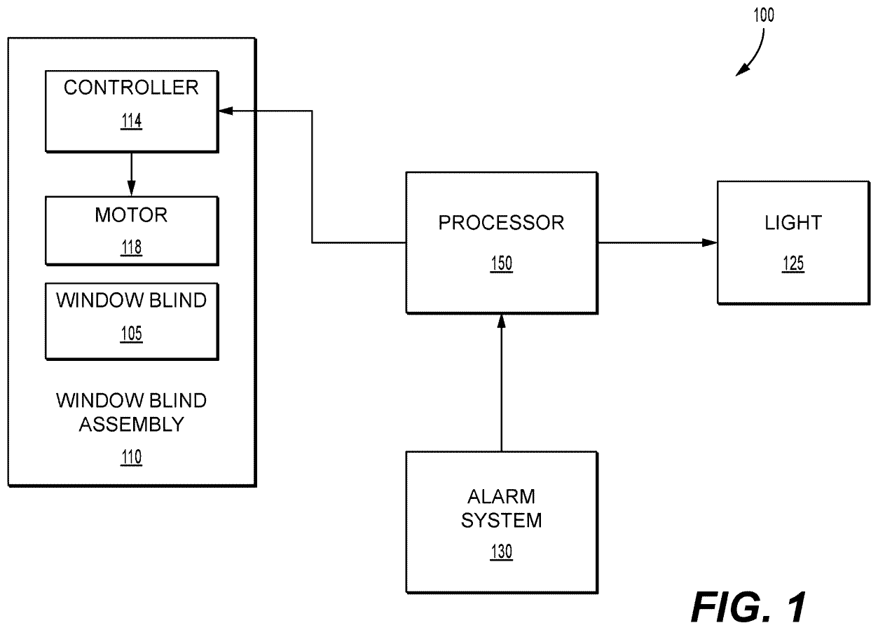

With reference to FIG. 1, one non-limiting embodiment of a window blind system 100 for deterring theft is described. The system 100 for aiding in deterring theft from a home or business has at least one window for which a window blind assembly 110 of the system 100 is installed. The system 100 includes an alarm system 130. Commercial alarm systems are often installed, maintained and monitored by home security system companies serving the residential or commercial market. These alarm systems typically allow the owner to arm the system when the owner leaves the premises. Often, the alarm system subsequently senses when a door is shut, indicating that there are no occupants inside the premises, a condition which may be referred to as an “away status.” In some cases, motion sensors inside the home or business can then be automatically activated by the alarm system 130 when this away status is attained.

The system 100 for deterring theft also includes a processor 150 that is communicatively connected to the alarm system 130. Implementation of the processor 150 is not specifically limited and could include or be formed from a variety of components, including but not limited to: a microprocessor, a computer-implemented controller, and control circuitry. The processor 114, in some non-limiting embodiments, is connected to the internet from which time and date information may be obtained. This information allows the system 100 to determine what part of the day it is and in particular whether it is nighttime.

The window blind assembly 110 includes a window blind 105. When in use, the window blind 105 is arranged and configured to selectively block at least some light transmission from outside of a window, at which the window blind 105 is installed, to an interior side of a structure in which the window is installed.

The window blind assembly 110 includes a motor 118 operatively connected to the window blind 105. The motor 118 is configured to selectively move the window blind 105 between at least an open position and a closed position. As will be described below, in some embodiments of the window blind 105, the open and closed positions correspond to relative positions of slats of the window blind 105. In at least some embodiments, the open position may not fully expose the window, with some portions of the window blind 105 still obscuring a portion of the window. The open position may, for example, refer to either a situation where the horizontal slats of a blind have been stacked together by translating the slats upwards exposing part of the window, or to a situation where the slats, instead of being translated upwards, have been rotated to allow light to enter the window. Correspondingly, the closed position may refer to a situation where the slats are not stacked together, and the slats are rotated in such a way to block light entering the window.

The window blind assembly 110 includes a controller 114 operatively connected to the motor 118 for selectively causing the motor 118 to move the window blind 105. The controller 114, including for example a central processing unit (CPU), is in communication with the processor 150. In some embodiments, the function of the processor can be amalgamated with or subsumed by those of the controller. Consequently, in some embodiments, it suffices to just have one of a processor or a controller. Where appropriate, more than one processor or controller may be used.

In the illustrated embodiment, the system 100 also includes a light 125 configured to be disposed in an interior of the house or structure in which the window blind assembly 110 is installed. The light 125 is communicatively and operatively connected to the processor 150, such that the processor 150 can cause the light 125 to operate. While illustrated as a separate component, in some embodiments the light 125 could be disposed in a portion of the window blind assembly 110. It is contemplated that the light 125 could be omitted in the system 100 in at least some embodiments. It is also contemplated that the system 100 and/or the processor 150 could be operatively connected to a light previously installed in the structure.

In operation, provided that the alarm system 130 is armed, i.e. the away status is initiated, and provided that it is nighttime, the processor 130 sends a close signal to the controller 114. In turn, upon receiving the close signal, the controller 114 sends a signal to the motor 118 to close the window blind 105. In at least some cases, the system 100 provides an advantageous arrangement such that at night when there are no occupants in the premises, the window blind 105 is closed to prevent unwanted parties from peering inside the premises.

People often manually close window blinds at night as a deterrent to burglars trying to break in. It is less common for window blinds to be closed during the day. Thus, if the window blinds were to close during the daytime when the owner leaves, this may alert a potential thief or unwanted party that there is no one present. In contrast, in the present technology, the window blind 105 is closed only if the away status is on and it is nighttime. In at least some embodiments, the controller 114 could further send a signal to the motor 118 to open the window blind 105 in situations where the alarm system is armed with the away status, and it is not night.

In embodiments including the light 125, when the alarm system 130 is armed with the away status and the window blind 105 is caused to close, the processor 150 could also control the light 125 to turn on inside the structure to further give the impression that a person is inside. In some cases, the light 125 could also be caused to flicker, thereby simulating the light patterns produced by a powered up television or monitor, again giving the impression that a person is inside.

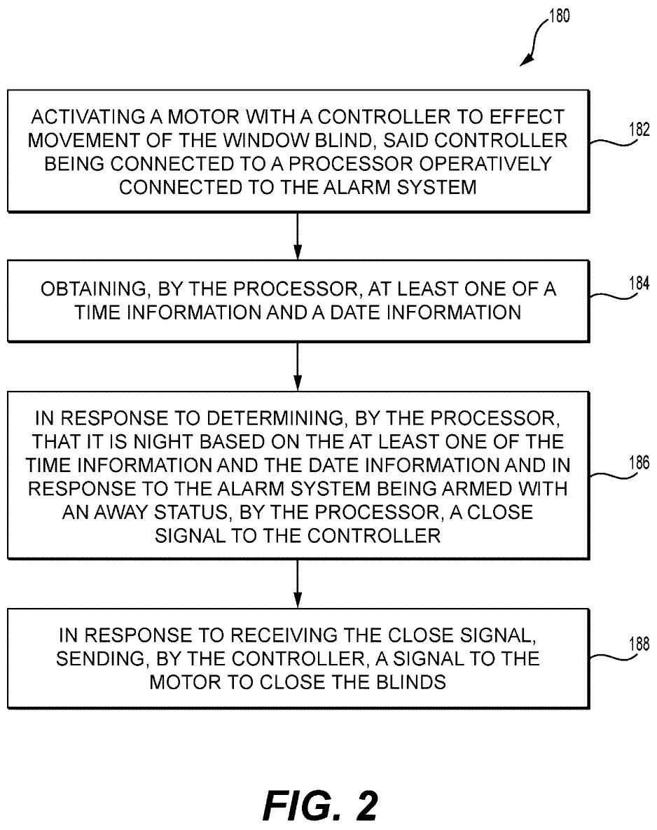

A method 180 for deterring theft from a home or business equipped utilizing the system 100 is illustrated schematically in FIG. 2.

The method 180 begins, at step 182, with activating the motor 118 with the controller 114 to effect movement of the window blind 105. In at least some embodiments, activating the motor 118 could include initiating/turning on the system 100 in order to provide power to the motor 118 and the window blind assembly 110 generally.

The method 180 continues, at step 184, with the processor 150 obtaining time information and/or date information. In at least some embodiments, the processor 150 could obtain the time and/or date information from an external source via an internet connection. In some cases, the processor 150 could retrieve the time and/or date information from a computer-implemented storage communicatively connected to the processor 150. Alternatively, the time and/or date information could be obtained from a clock, internal to the controller 114 or processor 150, that maintains the date and time.

In response to the alarm system 130 being armed with an away status and determining that it is nighttime, the method 180 continues, at step 186, with sending, by the processor 150, a close signal to the controller 114 of the window blind assembly 110.

In response to receiving the close signal, the method 180 terminates, at step 188, with the controller 114 sending a signal to the motor 118 to close the window blind 105.

In some embodiments, the method 180 further includes determining, by the processor 150, that it is not night at a current time based at least partially on the time information and/or date information. In some cases, the method 180 could include determining that it is no longer night, after having previously determined that it was night at an earlier time.

In some such cases, the method 180 further includes sending, by the controller 114, a signal to the motor 118 to open the window blind 105, in response to the alarm system 130 being armed with the away status and in response to determining that it is not night.

In some embodiments, the method 180 further includes causing the light 125 to turn on, in response to receiving the close signal. In cases, the method 180 further includes causing the light 125 to turn on and flicker to simulate a television display in response to receiving the close signal.

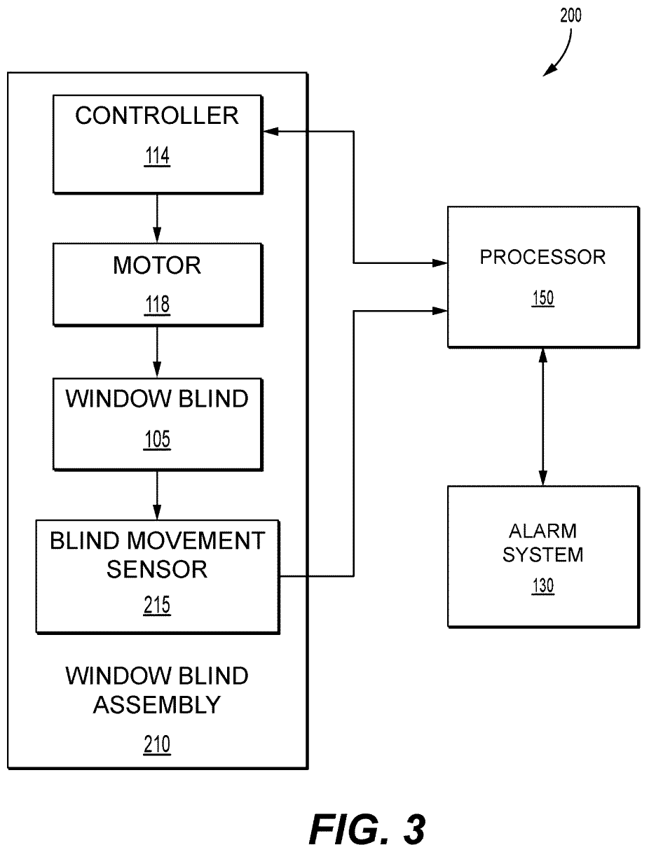

Another embodiment of a window blind system 200 according to the present technology is illustrated in FIG. 3. Elements of the system 200 that are similar to those of the system 100 retain the same reference numeral and will generally not be described again.

According to the principles of the present technology, the alternative or additional system 200 also employs the window blind 105 to aid in deterring theft from a house equipped with the alarm system 130. A window blind assembly 210 further includes a movement sensor 215 operatively connected to the window blind 105. The movement sensor 215 is configured and arranged to detect when the window blind 105 has been moved. In some cases, movement sensor 215 is configured and arranged to detect when the window blind 105 has been moved from a standby position. The standby position corresponds to a position where the window blind is typically disposed in a motionless state. For a roll down window blind, for example, the window cover or shade, when it is deployed, is in a motionless, vertically planar position, which is a standby position. Depending on the implementation, the movement sensor 215 could include an accelerometer and/or a tilt sensor. The movement sensor 215 is in communication with the processor 150, which in turn is in communication with the alarm system 130. As described above, the alarm system can be armed with an away status indicating that there are no occupants in the house/premises.

In operation, provided that the alarm system 130 is armed with the away status and the movement sensor 215 has detected that the window blind 105 has moved from the standby position, the processor 150 activates an intruder signal. The intruder signal could include various signals for aiding in deterring burglary, including but not limited to: an alarm, an alert to a smartphone, an alert to police, an alert to a security firm, a voice warning, and a light signal. Conveniently, some signaling hardware of a typical alarm system can be leveraged for use in the window blind system. For example, some embodiments of the alarm system 130 come equipped with a loud noise-making device that is activated when the alarm system 130 detects that an intruder has opened a door. This same device can be used to sound the alarm signal in response to the window blind 105 moving from a standby position. It will be appreciated that the foregoing window blind system 105 could thus aid in thwarting a housebreaking through a window. When a thief, for example, disturbs the window blind 105 from the standby position to a degree that triggers the movement sensor 215, an intruder signal could be sent.

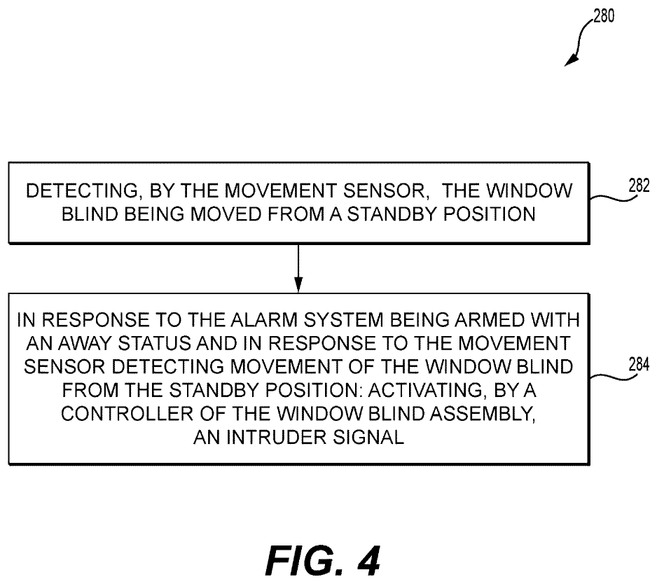

A method 280 for deterring theft from a home or business equipped with the system 200 is illustrated schematically in FIG. 4.

The method 280 begins, at step 282, with detecting, by the movement sensor 215, the window blind 105 being moved from a standby position.

The method 280 continues, at step 284, with activating the intruder signal by the processor 150, in response to the alarm system 130 being armed with an away status and in response to the movement sensor 215 detecting movement of the window blind 105 from the standby position. In some embodiments of the system 200, it is contemplated that the controller 114 of the system 200 could be communicatively connected to the alarm system 130, omitting the processor 150. In some such embodiments, the method 280 could include activating the intruder signal by the controller 114.

In some embodiments of the method 280, the intruder signal could include at least one of an alarm, an alert to a smart phone, an alert to police, an alert to a security firm, a voice warning, and a light signal.

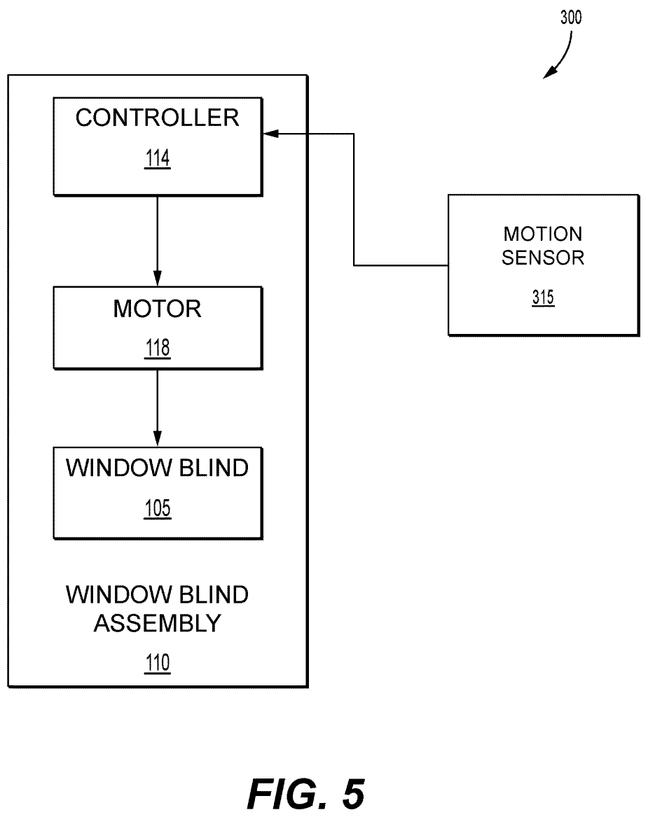

Another embodiment of a window blind system 300 according to the present technology is illustrated schematically in FIG. 5. Elements of the system 300 that are similar to those of the system 100 retain the same reference numeral and will generally not be described again.

According to the principles of the present technology, the alternative or additional system 300 employs the window blind assembly 110 to aid in deterring theft from a house or business.

The system 300 includes a motion sensor 315. The motion sensor 315 is in communication with the controller 114. The motion sensor 315 is disposed so that the motion sensor 315 can detect motion of an interloper or unwanted party who is in an exterior of and proximal to the window. In some embodiments, the motion sensor 315 is disposed outdoors and affixed to an exterior component of the house, such as an exterior wall or soffit. However, other locations for the motion sensor are contemplated such as proximal to a door and interior to the house with a motion sensor that can for example detect external movement on the other side of a door.

In operation, the motion sensor 315 detects motion of the interloper, sending a signal to the controller 114 to actuate the motor 118 to thereby close the window blind 105. Advantageously, the system 300 aids in thwarting the interloper who may be trying to surveil the interior of a home for the purpose of breaking in, for example. When the motion detector 315 detects a person who is outside near the window, a signal is sent that causes the motor 118 to close the window blind 105, preventing the person from peering in through the window.

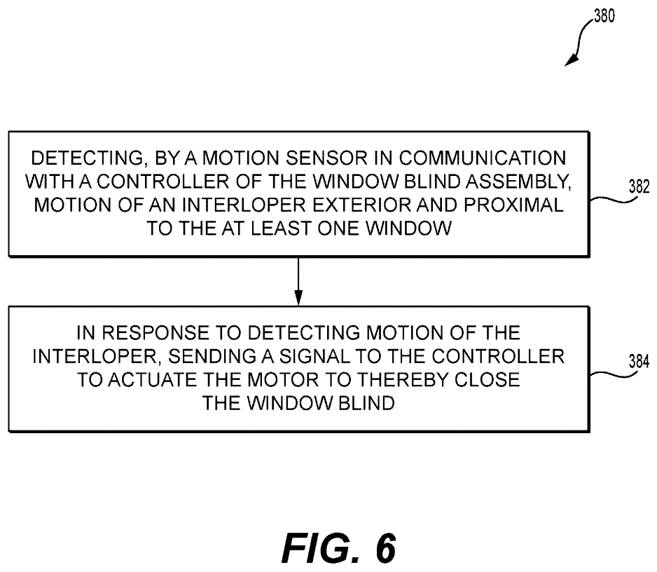

A method 380 for deterring theft from a home or business equipped with the system 100 is illustrated schematically in FIG. 6.

The method 380 begins, at step 382, with detecting, by the motion sensor 315, motion of an interloper exterior and proximal to one or more windows.

The method 380 continues, at step 384, with sending a signal to the controller 114 to actuate the motor 118 to thereby close the window blind 105 in response to detecting motion of the interloper.

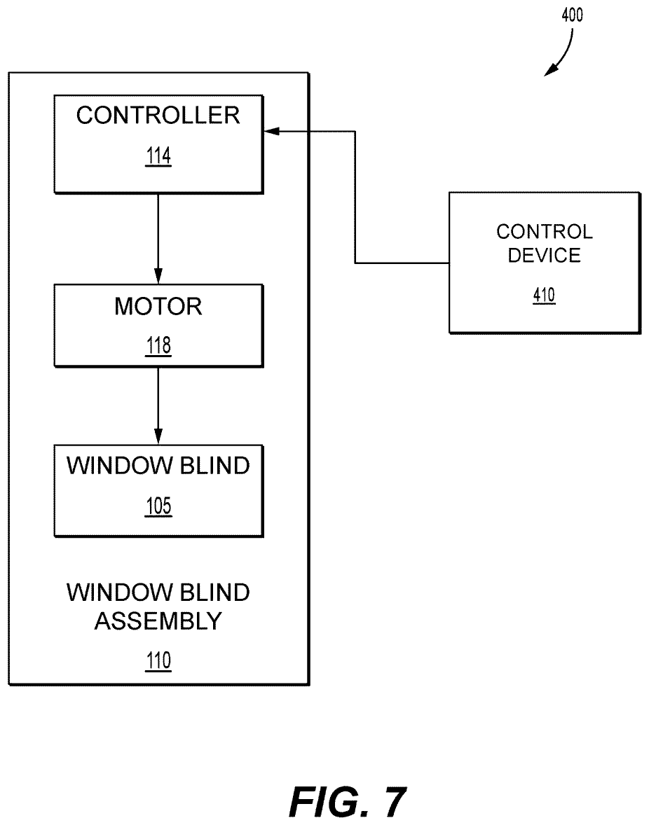

Yet another embodiment of a window blind system 400 according to the present technology is illustrated schematically in FIG. 7. Elements of the system 400 that are similar to those of the system 100 retain the same reference numeral and will generally not be described again.

The window blind system 400 is a crescendo alarm-window blind system 400. The crescendo alarm-window blind system includes the window blind assembly 110 configured and arranged to be installed at a window of a room. The system 400 further includes a control device 410, also referred to as the device 410, communicatively connected to the controller 114 of the window blind assembly 110. The device 410 can be implemented in a variety of ways, including but not limited to a dedicated remote control and a smartphone.

The device 410 is configured to permit a user to choose an automatic blind opening mode for selectively controlling the window blind 105. The crescendo alarm-window blind system 40 allows the movement of the window blind 105 to be coordinated with a crescendo alarm. A crescendo alarm is a wake-up alarm whose alarm is sounded over a crescendo period, T, of time. During this period T, the volume of the alarm gently increases to prevent a person from being woken abruptly. Although in a preferred embodiment the crescendo period is greater than zero, a period of T=0 is also possible. This latter embodiment where T=0 corresponds to a regular alarm that is activated instantly at one volume without a gradual rise in volume.

In operation, after choosing the automatic blind opening mode with the device 410, setting the wake-up alarm causes the motor 118 to automatically open the window blind 105 at some time after the wake-up alarm is set. The motor 118 can automatically open the window blind 105 over an opening period S. For example, for embodiments of the window blind 105 having slats, each slat can rotate open over the opening period S, resulting in a gradual increase of light into the room. In at least some embodiments, the opening period S at least partially overlaps with the crescendo period T. Advantageously, there is no need to program the opening of the window blind 105 every time the user wants the blind to open with the activation of the user's alarm. Instead, provided the automatic blind opening mode is selected, setting the alarm causes the blind to automatically open sometime thereafter.

As one non-limiting example, the crescendo period T may be set to be Monday morning from 6:30 am to 6:40 am for a total alarm duration of 10 minutes. As part of the automatic blind opening mode selection process, the opening period may be set to coincide with the last five minutes of the crescendo period (corresponding in this example to Monday morning from 6:35 am to 6:40 am for a total opening duration of 5 minutes). In one embodiment, both T and S are configurable and can be set with the use of the device 410. During the automatic blind opening mode selection process, S can be chosen to be “the last five minutes of the crescendo period,” and there is then no need to keep reprogramming the blind to open on other days: setting the alarm on a future date is sufficient to automatically cause the window blind 105 to open (provided the automatic blind opening mode is on). Advantageously, light can start entering the room at about the time that the crescendo alarm is activated helping the occupant wake up more comfortably.

Various blind opening modes are contemplated. In one embodiment, the blind opening mode could be set before the alarm is set. As one non-limiting example, an application or interface of the device 410 may ask the user: “Do you wish that the window blind open every time that the crescendo alarm sounds?” In response to an answer of “yes,” the application would then ask: “Do you want the window blind to start opening before, when, or after the alarm sounds?” If “before,” then “How many minutes before the alarm sounds would you like the window blind to start opening?” If “after,” then “How many minutes after the alarm sounds would you like the window blind to start opening?” The application could similarly ask: “Do you want the window blind to stop opening before, when, or after the alarm stops?” If “before,” then “How many minutes before the alarm stops would you like the window blind to stop opening?” If “after,” then “How many minutes after the alarm stops would you like the window blind to stop opening?” In such case, the system 400 could return an error if a user requests that the window blind starts opening after the user requests that the window blind stop opening. Choosing the “when” option twice could further indicate that the user wants S and T to coincide. An opening period S=0 is also possible if the user wants to open the window blind 105 as quickly as possible.

It will be appreciated that the control device 410 can send a signal to the controller via an intermediate processor. For example, a smartphone can send instructions to a remote processor located in the cloud. In turn, the processor can send a signal to the controller based on the instructions, which signal causes the motor to actuate. Alternatively or additionally, the controller can include various processors that are remote from each other. After the control device sends instructions to the first processor of the controller, various signals can be passed on from one processor of the controller to the next until the motor receives an actuating signal that causes the blind to move.

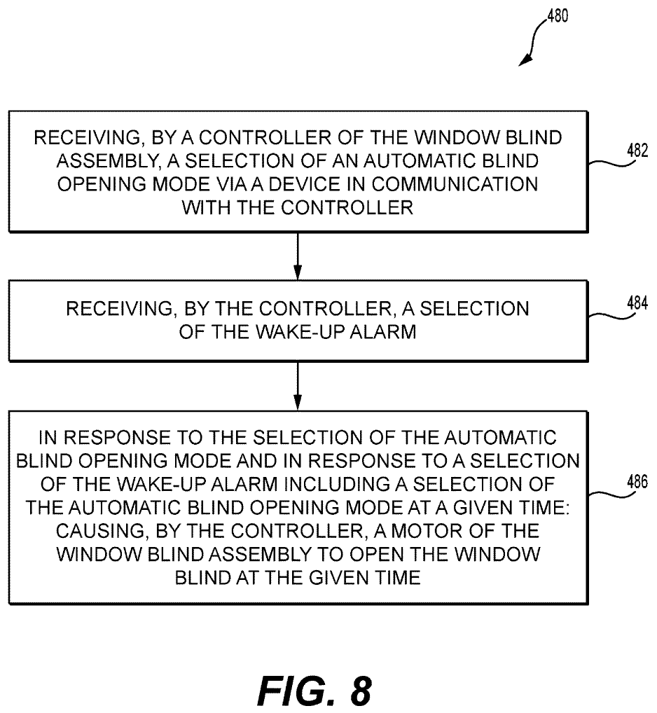

A method 480 for operating a wake-up alarm in concert with opening of a window blind utilizing the system 400 is illustrated schematically in FIG. 8.

The method 480 begins, at step 482, with receiving, by the controller 114, a selection of an automatic blind opening mode via the device 410.

The method 480 then continues, at step 484, with receiving, by the controller 114, a selection of the wake-up alarm. The selection of the wake-up alarm could include date and/or time information for scheduling the wake-up alarm for the user.

In response to the selection of the automatic blind opening mode and in response to a selection of the wake-up alarm including a selection of the automatic blind opening mode at a given time, the method 480 continues, at step 486, with causing, by the controller 114, the motor 118 to open the window blind 105 at the given time.

In some embodiments, the wake-up alarm is a crescendo alarm which when activated increases in volume over a crescendo period T>0. It is contemplated that in some such embodiments, causing the motor 118 to open the window blind 105 at the given time includes causing the window blind 105 to gradually open over an opening period S>0 that at least partially overlaps with the crescendo period T.

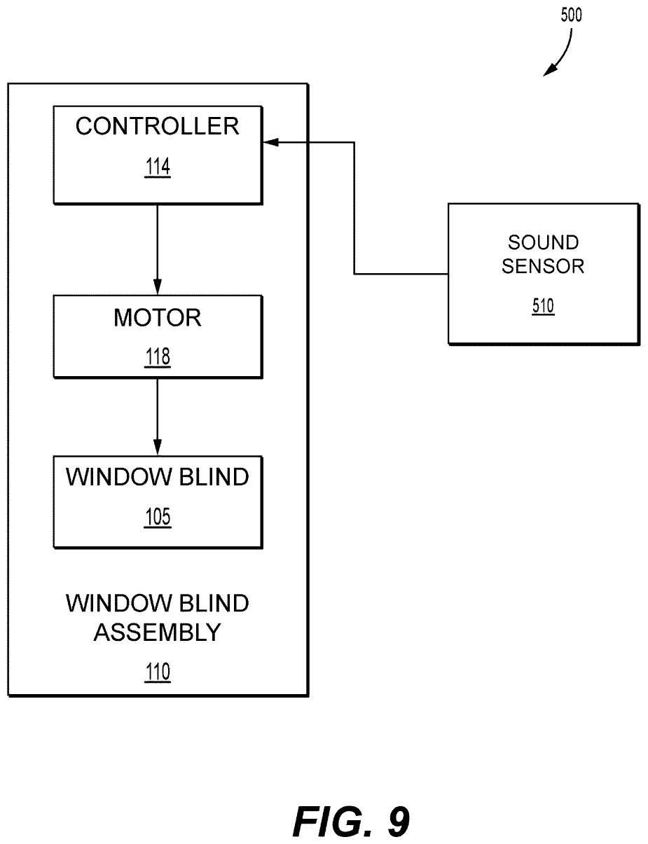

Yet another embodiment of a window blind system 500 according to the present technology is illustrated in FIG. 9. Elements of the system 500 that are similar to those of the system 100 retain the same reference numeral and will generally not be described again.

In another embodiment consistent with the principles of the present technology, a window blind system 500 includes the window blind assembly 110 and a sound sensor 510. The sound sensor 510 is communicatively connected to the controller 114. While illustrated separately from the window blind assembly 110, it is contemplated that the sound sensor 510 could be integrated into the assembly 110.

The sound sensor 510 is trained, configured, and/or arranged to detect an alarm sound. In the present example, the alarm sound is the same sound that a wake-up alarm emits when activated. For example, this sound can be music or a sequence of beeps. The sound sensor 510 is trained to identify this alarm sound. In response to identifying the alarm sound, the sound sensor is configured to send a signal to the controller 114 to cause the motor 118 to open the window blind 105. Thus, when the alarm sounds, the window blind 105 starts to open, again providing a more comfortable wake-up experience for the user.

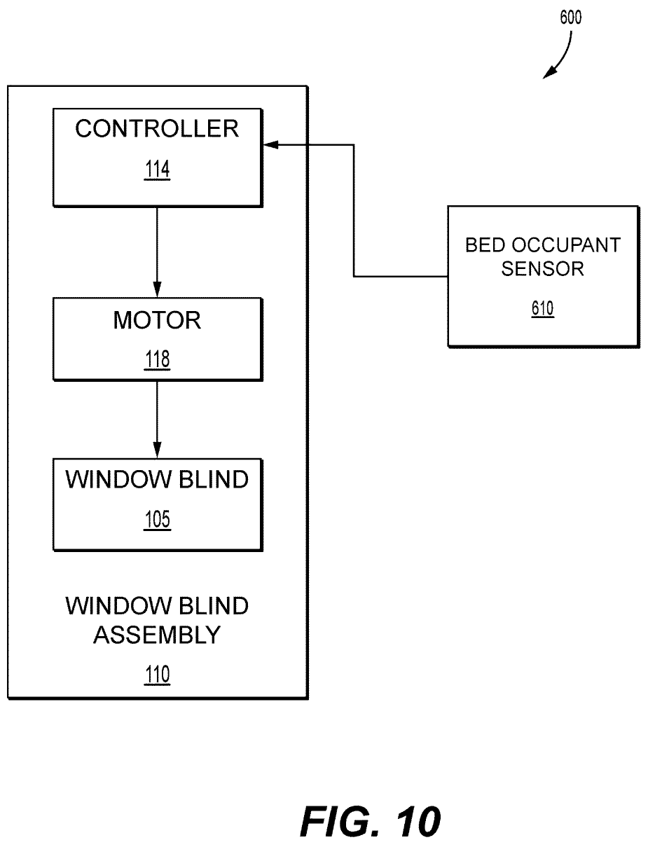

Another embodiment of a window blind system 600 according to the present technology is illustrated in FIG. 10. Elements of the system 600 that are similar to those of the system 100 retain the same reference numeral and will generally not be described again.

The window blind system 600 is configured and arranged to be installed in a room containing a bed. The system 600 includes a bed occupant sensor 610 communicatively connected to the controller 114. The bed occupant sensor 610 is configured for sensing whether a person in the room is occupying the bed. In at least some embodiments, the sensor 610 operates by monitoring the weight exerted on a force pad under the mattress of the bed. In at least some embodiments, the bed occupant sensor 610 could be triggered by the weight of a person on at least a portion of the sensor 610.

In operation, the bed occupant sensor 610 senses that the person has occupied the bed and subsequently sends a signal to the controller 114 to cause the motor 118 to close the window blind 105. Similarly, when the person has gotten out of the bed, the bed occupant sensor 610 sends a signal to the controller 114 to cause the motor 118 to open the window blind 105.

In one embodiment, the bed occupant sensor 610, or the sensor 610 in combination with other components such as the controller 114, is capable of determining whether more than one person is occupying the bed. For this purpose, two force pads or one long force pad of the sensor 610 may be used. In such a case, the signal that causes the controller 114 to close the window blind 105 may be sent only after two persons occupy the bed, and the signal that causes the controller 114 to open the window blind 105 may be sent only after no one occupies the bed.

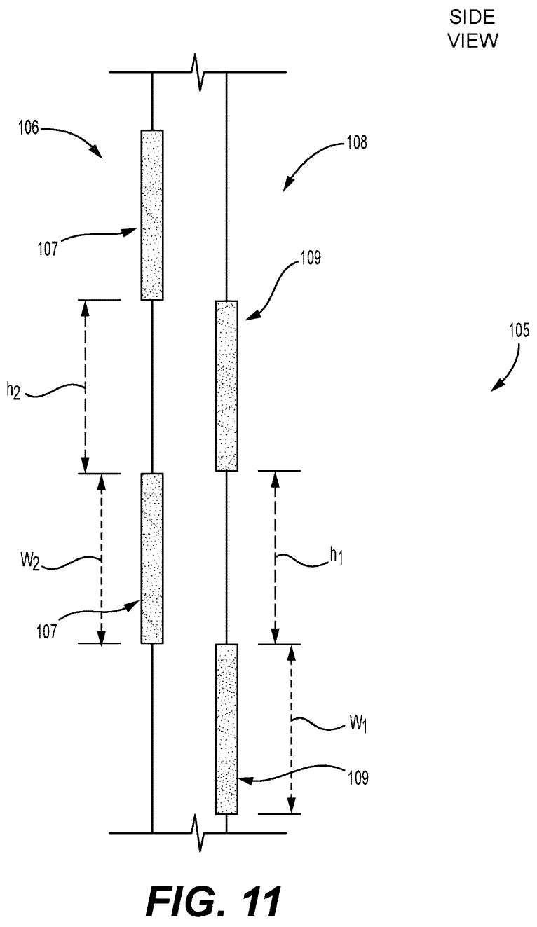

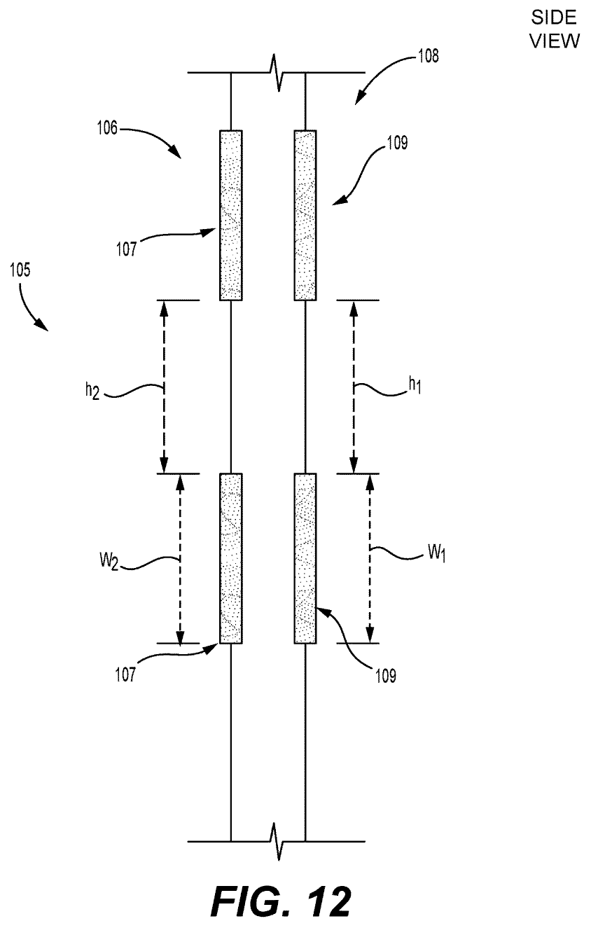

With reference to FIGS. 11 and 12, one non-limiting embodiment of the window blind assembly 110, which can be used in the foregoing embodiments, is illustrated. The window blind assembly 110 includes a first panel 106 of vertical spaced apart slats 107, the distance between adjacent slats (as measured from the bottom of one slat 107 to the top of the neighboring slat 107) being h₁ and the vertical width of each slat being W₁.

The window blind assembly 110 also includes a second panel 108 of slats parallel to the first panel 106. The second panel 108 has slats 109 spaced apart such that the distance between adjacent slats 109 is h₂ and the vertical width of each slat 109 is w₂ with h₂=w₁=h₁=W₂. It is noted that while only four slats 107, 109 are illustrated, it is contemplated that the number of slats 107, 109 could vary in different embodiments, including having more than four slats 107, 109. In some embodiments, the last set of equalities need not hold.

The slats 109 of the second panel 108 are capable of translating, either with manual operation or with the help of the motor 118. As is illustrated in FIG. 12, to open the window blind 105, the slats 109 of the second panel 108 are translated to align with the slats 107 of the first panel to thereby allow light to enter between the slats 107, 109. Similarly, to close the window blind 105, the slats 109 of the second panel 108 are translated to be staggered with respect to the slats 107 of the first panel 106 to thereby block the light (FIG. 11). No rotation of slats 107, 109 need occur. Instead, the only motion is translation of one-half the number of slats 109 by one slat width. It is also contemplated that the first panel 106 of slats 107 could move relative to the second panel 108 in some embodiments.

Depending on the embodiments, the slats 107, 109 could be disposed between the two panes of a window, or alternatively, the stationary slats 107 could be outside the window, while the translatable slats 109 could be inside the window, or vice versa. Advantageously, if only the one column of slats 107, 109 is inside the window, the region and/or volume needed inside the window to accommodate the slats 107, 109 is just approximately the thickness of the slat (~1 mm in the present embodiment). Even if both columns (panels 106, 108) are inside the window, because the movement of the slats 107, 109 is restricted to vertical translation, the thickness required between the two panes could be limited to just approximately one centimeter or less.

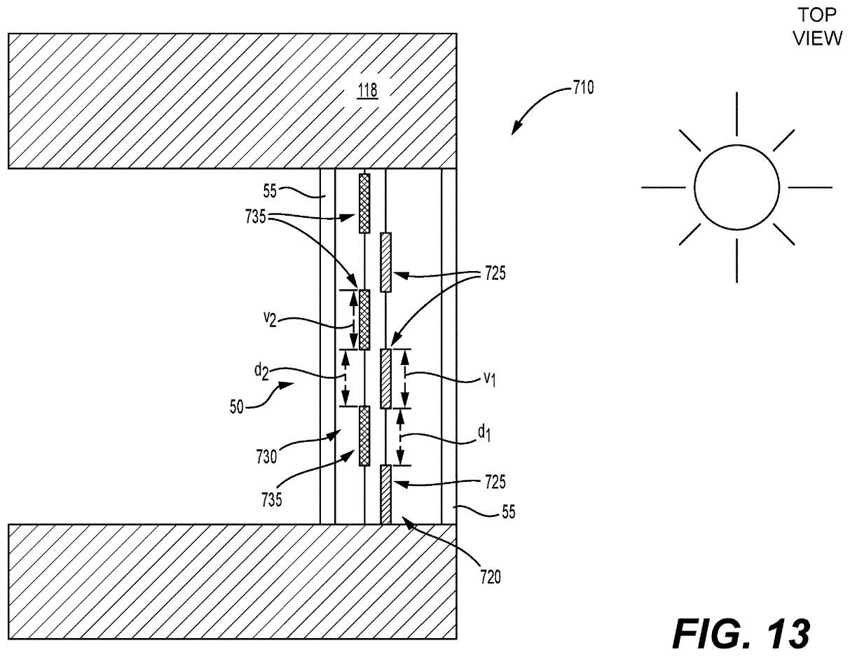

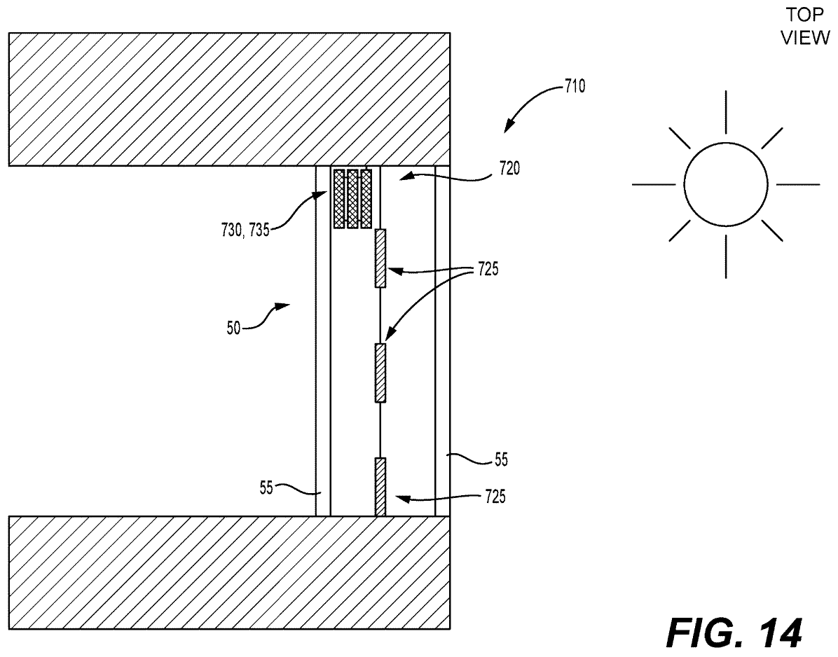

Another embodiment of a window blind assembly 710 according to the present technology is illustrated in top views in FIGS. 13 and 14. In at least some embodiments, the window blind assembly 710 could replace the window blind assembly 110 in the system 100 or other systems described herein. In contrast to the slats of the assembly 110, slats of the window blind assembly 710 extend vertically.

The window blind assembly 710 includes a first panel 720 of horizontally spaced apart slats 725, the distance between adjacent slats (as measured from one lateral side of one slat 725 to an opposite lateral side of the neighboring slat 725) being di and the horizontal width of each slat 725 being v1.

The window blind assembly 710 also includes a second panel 730 of slats parallel to the first panel 720. The second panel 730 has slats 735 spaced apart such that the distance between adjacent slats 735 is de and the horizontal width of each slat 735 is v₂with d₂=v1=d₁=v₂. It is noted that while only six slats 725, 735 are illustrated, it is contemplated that the number of slats 725, 735 could vary in different embodiments, including having more or fewer than six slats 725, 735.

The slats 135 of the second panel 130 are capable of translating, either with manual operation or with the help of the motor 118. When the window blind 710 is closed, the slats 735 of the second panel 730 are translated to be staggered with respect to the slats 725 of the first panel 720 to thereby block the light (FIG. 13). To open the window blind 710, the slats 735 are translated to one side and stacked (FIG. 14). No rotation of slats 725, 735 need occur. It is also contemplated that the first panel 720 of slats 725 could move relative to the second panel 730 in some embodiments.

In the illustrated embodiment, the slats 725 of the first panel 720 contain an electrochromic material, which changes color and/or opacity when a voltage is applied. The slats 725 is operatively connected to a power source (not shown). Thus, the slats 725 are configured to block ultraviolet, visible or (near) infrared light very quickly and on demand. In at least some embodiments, the slats 735 include photovoltaic cells (not separately identified) for producing power from sunlight incident thereon. In some cases, the photovoltaic cells of the slats 735 could be operatively connected to the slats 725 for providing power to the electrochromic material of the first panel 720. When in a closed arrangement or configuration, a front view of the window blind 710 would appear to have alternating electrochromic and photovoltaic slats 725, 735. In some embodiments, the window blind 710 could include a light sensor to determine the amount of light entering the room. The amount of dimming of the electrochromic material-which is to say the voltage that is applied thereto-could then be based at least in part on the amount of light detected by the light sensor.

As shown in FIG. 14, the slats 735 of the second panel 730 can assume a retracted configuration in which the slats 735 are stacked adjacent to each other. It will be appreciated that a configuration in which the slats 735 are retracted and no voltage is applied to the slats 725 of the first panel 720 results in the combined slats 725, 735 blocking the least amount of light.

There are several advantages to using electrochromic material. Conveniently, this material can be powered with the photovoltaic slats 735 by applying a voltage needed to achieve a level of dimming. No connection to the electrical grid of a building (normally performed by an electrician) may be required. While electrochromic glass is more expensive than regular glass, according to the present technology, about half the amount of electrochromic material may be used compared to replacing a window with electrochromic glass. A retrofit solution is afforded by adding electrochromic material as a film that adheres to the outside of a window. A passive electrochromic film is also available and marketed as Tintuitive™ photochromic self-tinting smart film by Smartglass™ Technologies of Montreal, Canada. There is the option to not obscure any part of the window at all by applying no voltage to the electrochromic material and moving the slats 735 into the retracted position manually or with the motor 118 to let the maximum amount of light in. Different, continuous degrees of dimming are possible with the electrochromic material by applying varying voltage. Electrochromic material further permits, in at least some embodiments, the slats 735 to be used as displays. When dimmed, the electrochromic material can act as a screen onto which an image can be projected. Together with an ethernet link, rich images could be displayed. Alternatively, by selectively applying different voltages to different portions of the electrochromic material, images can be created by the material itself due to the contrast in color and brightness.

Coupling of the photovoltaic slats 735 to the electrochromic slats 725 could further act as a feedback loop, wherein the more current produced by the photovoltaic slats 735, the more voltage is applied to the electrochromic slats 725, which in turn darkens the room, which in turn, reduces the current produced by the solar photovoltaic slats 735, which then causes less voltage to be applied to electrochromic slats 725, which lightens up the room, etc., creating a steady state.

Instead of electrochromic, thermochromic or photochromic material could be used in some embodiments. There are further certain electrochromic materials that also have photovoltaic properties. See for example a recent scientific article by Cánovas-Saura, “Portable Photovoltaic-Self-Powered Flexible Electrochromic Windows for Adaptive Envelopes,” Electron. Mater. 2021, 2(2), 174-185. Electrochromic-photovoltaic material could be utilized in the window blind 105.

As is further illustrated in FIGS. 13 and 14, the slats 725, 735 are disposed between two windowpanes 55 of a multi-paned window 50. It is contemplated that the slats 725 and/or the slats 735 could be disposed between the panes 55 of the window 50. By placing slats 725, 735 between the windowpanes 55, the slats 725, 735 are protected from damage (for example from pets) and remain dust free, for example. By confining the motion of the slats of the second panel in between the panes 55 to just translation, it will be appreciated that the minimum distance required to accommodate the slats 725, 735 between the windowpanes 55 can be smaller than if the slats 725, 735 were arranged for rotating. The photovoltaic slats 735 of the second panel 730 can be operated with the motor 118, which is especially useful if the slats 735 of the second panel 730 are disposed between the windowpanes. When the slats 725, 735 are external to the window 50 (i.e., not in between the windowpanes), then the slats 725, 735 can be moved manually or with the assistance of the motor 118.

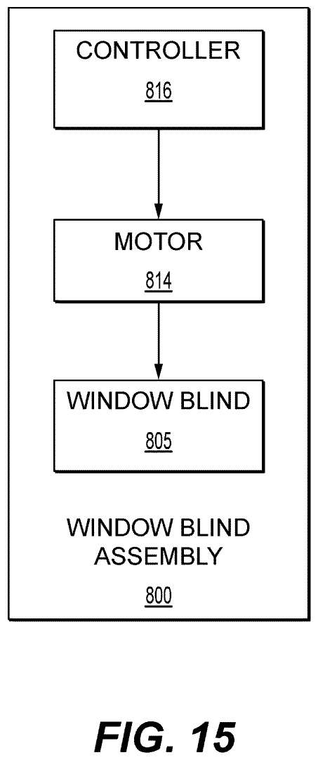

With reference to FIGS. 15 to 18, there is illustrated a window blind system 800 according to another non-limiting embodiment of the present technology.

The window blind system 800, also referred to herein as the system 800, includes a window blind 805. The window blind 805 includes a plurality of rotatable slats 808. While illustrated schematically as horizontally extending slats 808, rotatable about a horizontal axis, it is contemplated that vertically extending slats could be used in different embodiments.

By the present technology, the rotatable slats 808 each includes photovoltaic material 809, allowing the slats 808 to generate energy using light incident thereon. It is contemplated that only a subgroup of the rotatable slats 808 could have the photovoltaic material 809 disposed thereon in some embodiments. It is also contemplated that only some portions of the some of the slats 808 could include the photovoltaic material 809. As one non-limiting example of use of such an arrangement, the slats 808 could be used to generate energy when the window blind 805 is deployed to prevent heating of the room in which the assembly 800 is installed. Collection and/or use of the energy generated may be performed according to one or more of the above described window blind assemblies.

The system 800 also includes one or more motors 814 for operating the window blind 805. While one motor 814 is schematically illustrated, the exact number of motors 814 could vary depending on various details of the particular embodiment. The system 800 further includes a controller 816 operatively connected to the motor 814. The controller 816 is configured to control operation of the motor 814 to rotate the slats 808 and lift or lower the slats 808 into extended, partially open, and/or retracted positions (not shown).

According to the present technology, the system 800, and more particularly, the window blind 805 further includes one or more probing slats 810. In the illustrated embodiment, the window blind 805 includes one probing slat 810. It is contemplated that more than one probing slat 810 could be included in different embodiments. Also, in a further embodiment, the probing slat 810 may in fact be one of the rotatable slats, with some minor alterations thereto that may not be very discernible on a cursory glance.

The probing slat 810, in conjunction with the controller 816, is arranged and configured to monitor light received at the window blind 805 and then control operation of the window blind 805 based at least in part on information related to the light received at the window blind 805. In the present embodiment, the probing slat 810 and the controller 816 determine an intensity profile of light received at the window blind 805 (further described below). It is also contemplated that alternative or additional measurement values or calculations could be used in determining an operation of the window blind 805, depending on the embodiment.

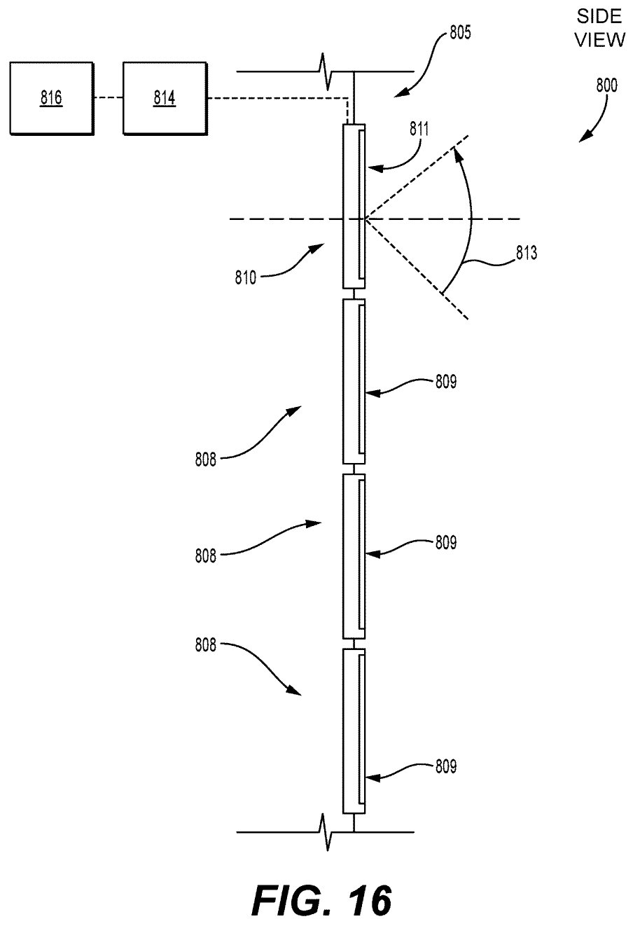

The probing slat 810 includes a light sensor 811 for sensing and measuring light irradiance incident on the probing slat 810. By the present embodiment, the light sensor 811 includes and is formed at least in part from photovoltaic material. It is contemplated that different types of light sensors could be used in different embodiments. The controller 816 is communicatively connected to the light sensor 811 (illustrated schematically in FIG. 16).

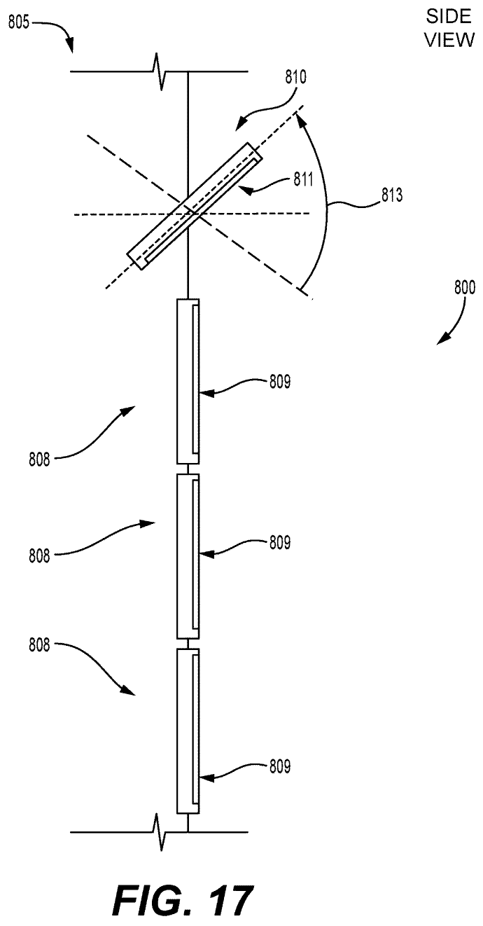

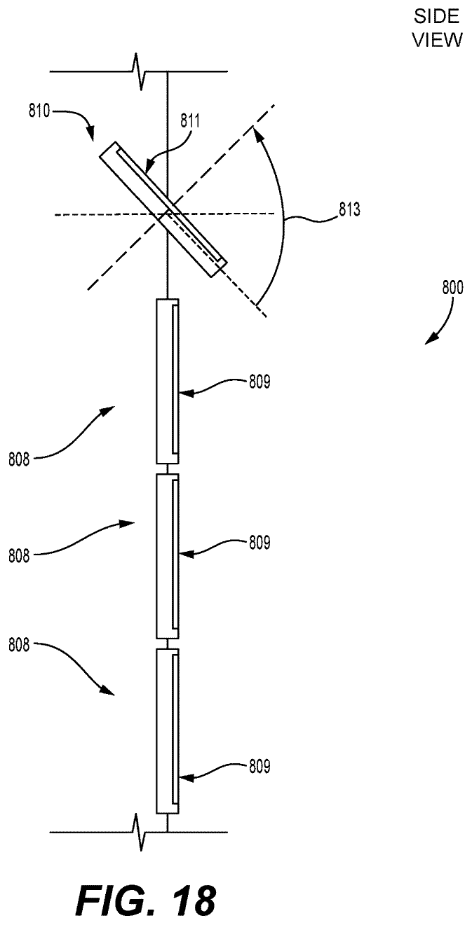

By the present technology, the probing slat 810 is rotated over a range of angles 813 to determine the intensity profile of light received at the window blind 805. Specifically, the controller 816 is configured to control the probing slat 810 to automatically rotate over the range of angles 813 to enable the light sensor 811 to measure an intensity profile of light intensity (irradiance) versus angle of orientation of the probing slat 810. In FIG. 16, the probing slat 810 is illustrated at a center position, with the probing slat 810 being generally aligned with the rotating slats 808 is a vertically-aligned, closed, extended position. One non-limiting example of the range 813 is illustrated, with a partially downward facing minimum position of the probing slat 810 being illustrated in FIG. 17 and a partially upward facing maximum position of the probing slat 810 being illustrated in FIG. 18.

The range of angles may be a full 360 degrees for ease of manufacturing, but this full range may be more than is desirable. For example, 180 degrees or less may be adequate to sample the external light. It will also be appreciated that a duty cycle with at least two time periods may be indicated. The first time period t1 sets the amount of time needed for the slats to rotate over their full range, such as 360 degrees. The second time period t2 sets the amount of time between rotations, in other words, sets the amount of time during which the slats do not rotate. A periodic setting may be used such that the slats rotate during a time t1, followed by a period t2 of no rotation, followed by a period t1 of rotation and then no rotation for t2, etc.

The controller 816 is then configured to, based on the determined intensity profile, identify an angle for the rotatable slats 808 that maximizes energy generation from the photovoltaic material 809. The operation of the motor 814 is thus based at least in part on the intensity profile via the determination made by the controller 816. In at least some embodiments, the intensity profile could be used for heat management in a building in which the window blind 805 is installed, where the slats 808 could be positioned to absorb a maximum possible light energy (based on the intensity profile) in order to reduce light incidence, and thus heating, in the building.

In order to determine the intensity profile over different periods of time, or at a particular time, the controller 816 is configured to control a sampling time, also referred to as a period of time of profile determination, of the rotation of the probing slat 810 over the angle range 813. This sampling time is typically equal to t1, as described above. The controller 816 is also configured to control a sampling spacing, defined by the time between one sampling time and a subsequent sampling time, which typically is t2 as described above.

As one non-limiting example, the controller 816 can control the probing slat 810 with a sampling time of less than one minute and a sampling spacing of ten minutes. In such a schedule, the probing slat 810 rotates through the full range of angles 813 in the period of less than one minute, starting again every ten minutes. The angle of best energy generation, and thus the angle of orientation of the rotating slats 808, could then be adjusted every eleven minutes.

As another non-limiting example, the controller 816 could control the probing slat 810 with a sampling time of greater than one hour, with a sampling spacing of less than one minute. In such a schedule, the probing slat 810 rotates through the full range of angles 813 in the period of over an hour, starting again in less than a minute. The angle of best energy generation, and thus the angle of orientation of the rotating slats 808, could then be adjusted every hour, based on a longer scan of the intensity profile. In one or more of the examples cited above, the controller 816 could be configured to cause the probing slat 810 to rotate through the range of angles 813 for at least twelve hours. The probing slat may rotate over its range of angles in either a continuous or incremental fashion, similar to how a second hand on a mechanical watch can sweep continuously or tick in increments.

It is noted that while the illustrated embodiment shows the probing slat 810 rotating independently of the remaining slats 808, it is contemplated that the slats 808 could be operated to rotate when the probing slat 810 rotates. Such a situation may make sense from a manufacturing point of view: instead of dedicating just one slat for probing, with the requisite dedicated motor circuitry, it may be easier to manufacture a set of slats, one of which is the probing slat, that can all rotate in unison; some consideration must then be paid to the nuisance of having all the slats rotating, with a short sample time making most sense in such case.

The program code embodied in any of the applications described herein is capable of being individually or collectively distributed as a program product in a variety of different forms. In particular, the program code may be distributed using a computer readable media, which may include computer readable storage media and communication media. Computer readable storage media, which may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, radiofrequency (RF), infrared and other wireless media. Combinations of any of the above may also be included within the scope of computer readable media.

Although embodiments have been described above with reference to the accompanying drawings, those of skill in the art will appreciate that variations and modifications may be made without departing from the scope thereof as defined by the appended claims. For example, it will be appreciated that the controller described herein can include various processors that are proximal or remote from each other. The various processors of the controller can communicate with each other before an actuating signal is sent that results in some action, such as the emission of a sound or the movement of a blind.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1.-4. (canceled)

5. A method for deterring theft from a house equipped with an alarm system and a window blind assembly for a window, the window blind assembly having a movement sensor capable of detecting movement of a window blind of the window blind assembly, the method comprising:
detecting, by the movement sensor, the window blind being moved from a standby position; and
in response to the alarm system being armed with an away status and in response to the movement sensor detecting movement of the window blind from the standby position:
activating, by a controller of the window blind assembly, an intruder signal.

6. The method of claim 5, wherein the intruder signal includes at least one of an alarm, an alert to a smart phone, an alert to police, an alert to a security firm, a voice warning, and a light signal.

7. A method for deterring theft from a house, the house having at least one window equipped with a window blind assembly, the window blind assembly having a window blind and a motor for selectively moving the window blind, the method comprising:
detecting, by a motion sensor in communication with a controller of the window blind assembly, motion of an interloper exterior and proximal to the at least one window; and
in response to detecting motion of the interloper, sending a signal to the controller to actuate the motor to thereby close the window blind.

8. A method for operating a controller of a motorized window blind in concert with a wake-up alarm, the method comprising the step of:
in response to a) an automatic blind opening mode being selected with a device and b) the wake-up alarm being set for a given time, the controller causing a motor to open the window blind.

9. The method of claim 8, wherein the wake-up alarm is a crescendo alarm which when activated increases in volume over a crescendo period T>0.

10. The method of claim 9, wherein the step of causing the motor to open the window blind includes causing the motor to gradually open the window blind over an opening period S>0 that at least partially overlaps with the crescendo period T.

11. The method of claim 8, wherein the device is a smart phone.

12. The method of claim 8, wherein the device is a remote control.

13.-26. (canceled)

27. A window blind system comprising:
a window blind;
a motor for operating the window blind;
a controller to control the motor; and
a sound sensor in communication with the controller, said sound sensor capable of being trained to detect an alarm sound, wherein the sound sensor sends a signal to the controller to open the window blind in response to the sound sensor detecting the alarm sound.

28.-46. (canceled)
